(19) United States
(12) Patent Application Publication
(10) Pub. No.: US 2023/0267465 A1
(43) Pub. Date: Aug. 24, 2023

(54) METHOD TO SOLICIT A USER GENERATED RESPONSE TO DETERMINE IF A CONSUMER MADE A PURCHASE

(71) Applicant: CATALINA MARKETING CORPORATION, St. Petersburg, FL (US)

(72) Inventors: Zubin SINGH, St. Petersburg, FL (US); Kevin HUNTER, La Jolla, CA (US); Thierry ROULLIER, Chicago, IL (US); Jared HISLOP, St. Petersburg, FL (US)

(21) Appl. No.: 18/014,114

(22) PCT Filed: Jul. 1, 2021
(86) PCT No.: PCT/US2021/040211

§ 371 Date: Dec. 30, 2022

Related U.S. Application Data
(60) Provisional application No. 63/047,533, filed on Jul. 2, 2020.
(60) Provisional application No. 63/047,527, filed on Jul. 2, 2020.
(60) Provisional application No. 63/047,512, filed on Jul. 2, 2020.

(51) Int. Cl. G06Q 20/40; G06Q 20/20; G06Q 20/32; G06Q 20/22; G06Q 30/0238

(52) U.S. Cl. CPC G06Q 20/4014; G06Q 20/208; G06Q 20/3227; G06Q 20/2295; G06Q 20/3267; G06Q 30/0238

(57) ABSTRACT

A method to solicit a user generated response to determine if a consumer made a purchase is provided. The method includes retrieving a transaction information when a consumer is in a point of sale at a retail store. The transaction information is indicative of a purchase of one or more items identified with a unique product code. The method also includes providing, to the consumer, a transaction card indicative of at least a portion of the transaction information; requesting, from the consumer, a validation of the purchase and providing the transaction information to a server when the purchase is validated by the consumer. The method also includes allowing the consumer to modify the transaction information upon request. A system and a non-transitory, computer-readable memory storing instructions to perform the above method are also provided.

### CROSS-REFERENCE TO RELATED APPLICATIONS

The present disclosure is related and claims priority under 35 U.S.C. 119(e) to U.S. Prov. Pat. Appln. Nos. 63/047527, 63/047512, and 63/047533, all filed on Jul. 2, 2020, to Zubin SINGH, et-al., the contents of which are hereby incorporated by reference in their entirety, for all purposes.

### BACKGROUND

### Field

The present disclosure is related to creating, updating, and managing databases for consumer networks that enable the design and strategic planning of product manufacture, advertising campaigns, and in-store stock and display. More specifically, the present disclosure is directed to a mobile application installed in a mobile device of a consumer and configured to collect market-related information for a consumer database.

### Brief Background Description

Current trends in digital data collection and user-tracking from mobile devices have put a high burden on service providers to find mechanisms for preserving personalized identification information (PII) from users. Many platforms have relied heavily on data collection from network providers or device manufacturers, but privacy concerns in the context of current developments have compelled the latter to steer away from automatic device tracking and data-sharing. This has exposed many advertising platforms and other data-dependent services to a database depletion that may seriously impact campaign measurement and in turn jeopardize the ability to optimize media investments.

### SUMMARY

In a first embodiment, a computer-implemented method includes retrieving a transaction information when a consumer is in a point of sale at a retail store, the transaction information being indicative of a purchase of a one or more items identified with a unique product code when a transaction is triggered by a consumer panel application installed in a mobile device of the consumer. The computer-implemented method includes providing, to the consumer, a transaction card indicative of at least a portion of the transaction information and requesting, from the consumer, a validation of the transaction. The computer-implemented method also includes providing the transaction information to a server when the transaction is validated by the consumer, and allowing the consumer to modify the transaction information upon request.

In a second embodiment, a system includes a memory configured to store multiple instructions and one or more processors configured to execute the instructions. The one or more processors execute the instructions to cause the system to retrieve a transaction information when a consumer is in a point of sale at a retail store, the transaction information being indicative of a purchase of one or more items identified with a unique product code when a transaction is triggered by a consumer panel application installed in a mobile device of the consumer. The one or more processors also execute the instructions to provide, to the consumer, a transaction card indicative of at least a portion of the transaction information, to request, from the consumer, a validation of the transaction, to provide the transaction information to a server when the transaction is validated by the consumer, and to allow the consumer to modify the transaction information upon request.

In a third embodiment, a computer-implemented method includes activating a consumer panel application installed in a mobile device when a consumer is in a point of sale at a retail store. The computer-implemented method also includes triggering a transaction at the point of sale to allow a point of sale device to transmit a transaction information to a remote server, the transaction information being indicative of a purchase of one or more items identified with a unique product code, and receiving, via the consumer panel application, a transaction card indicative of at least a portion of the transaction information. The computer-implemented method also includes validating the transaction information via the consumer panel application.

In yet another embodiment, a system includes a means for storing instructions and a means for executing the instructions to cause the system to perform a method. The method includes retrieving a transaction information when a consumer is in a point of sale at a retail store, the transaction information being indicative of a purchase of a one or more items identified with a unique product code when a transaction is triggered by a consumer panel application installed in a mobile device of the consumer. The method also includes providing, to the consumer, a transaction card indicative of at least a portion of the transaction information, and requesting, from the consumer, a validation of the transaction. The method also includes providing the transaction information to a server when the transaction is validated by the consumer, and allowing the consumer to modify the transaction information upon request.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an architecture in a system for soliciting a consumer response to determine if a consumer made a purchase, according to some embodiments.

FIG. 2 illustrates details of exemplary devices used in one embodiment of the architecture of FIG. 1, according to some embodiments.

FIG. 3 illustrates screenshots of a transaction validation via a consumer panel application in a mobile device, according to some embodiments.

FIG. 4 is a flow chart illustrating steps in a method for soliciting a user generated response to determine if a consumer made a purchase, according to some embodiments.

FIG. 5 is a flow chart illustrating steps in a method for validating a transaction at a retail store via a consumer panel application installed in a mobile device, according to some embodiments.

FIG. 6 is a block diagram illustrating an example computer system with which the client and server of FIGS. 1 and 2 and the methods of FIGS. 4 and 5 can be implemented, according to some embodiments.

In the figures, elements and steps denoted by the same or similar reference numerals are associated with the same or similar elements and steps, unless indicated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

In the technical field of digital consumer reach out and advertisement, the current trend for data privacy and security protection imposes challenging conditions for data collection and campaign assessment. This has exposed many advertising platforms and other data-dependent services to a database depletion that may seriously impact campaign measurement and in turn jeopardize the ability to optimize media investments.

Embodiments as disclosed herein provide a technical solution to the above problem by creating an “opt-in” network of consumers that share at least some of their consumer history data with a centralized server via a consumer panel application. The centralized server collects the consumer data and applies data processing algorithms that enable the assessment of a larger population of consumers not necessarily registered in the consumer panel application. The consumers that download and run the consumer panel application are enticed to do so by offers, promotion, and value added certificates from the centralized server for selected products and vendors.

Embodiments as disclosed herein provide tools and techniques to implement a method to collect and link digital consumer panel (DCP) data to a semi-persistent in-store consumer loyalty card identifier. More specifically, embodiments as disclosed herein include a mobile application (e.g., a DCP application) installed in a client device used by a consumer that has opted-into a sales lift trackability tool.

In some embodiments, a third party vendor may be used as an incentive for the consumer to join a network and download the DCP application. For example, the third party vendor may offer a gift card, a discount on the purchase of an item, or any other type of incentive to the consumer. In some embodiments, any type of PII is expressly discarded or scrubbed from a database. In some embodiments, an encrypted gift card may be provided to the consumer, wherein the public and private keys are securely stored in the database.

Embodiments as disclosed herein provide the benefit of additional consumer data that will generate trust with clients of the server host (e.g., brand manufacturers, retail stores, and consumers alike) by building up, verifying, and updating an opt-in database. Further, methods as disclosed herein enable additional revenue streams for clients by providing avenues to improve product features and marketing strategies based on accurate and refined consumer data.

### General Overview

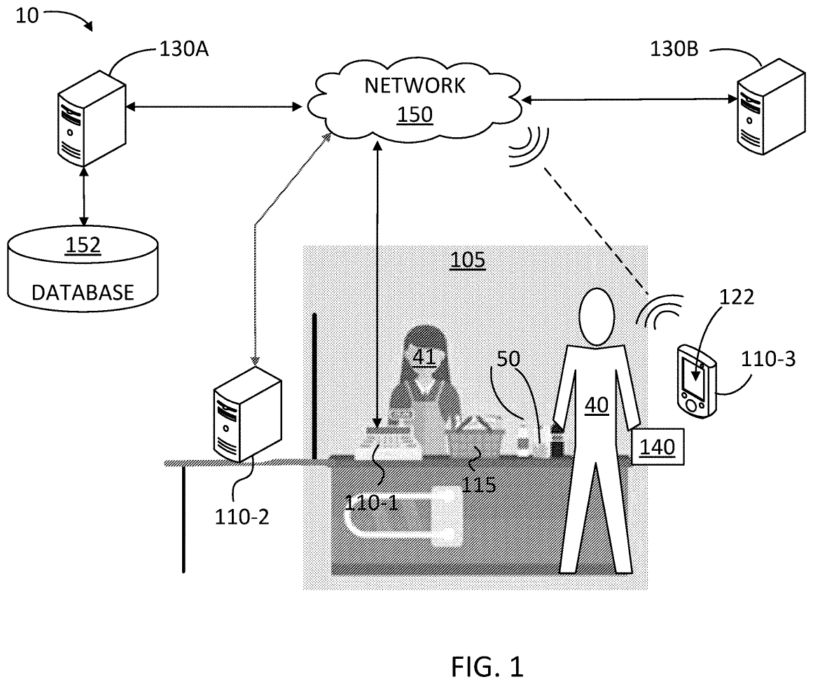

FIG. 1 illustrates an architecture 10 for soliciting a consumer response to determine if a consumer made a purchase, according to some embodiments. A consumer 40 stands in front of a point of sale (POS) 105 with a shopping basket 115 containing products 50 selected by consumer 40. Consumer 40 may have a frequent shopper identifier (FSCID) 140 that identifies consumer 40 as part of a retail store network. A cashier 41 scans each of the products in shopping basket 115 using a POS device 110-1, which is communicatively coupled with a remote server 130A via a network 150 (e.g., through an Ethernet link, an optical link, a wireless link, a cellular network, and the like). Accordingly, remote server 130A may have direct access to a list of products 50 in shopping basket 115, as they are scanned by cashier 41. In addition to POS device 110-1, POS 105 may also include a network terminal 110-2. Remote server 130A may host a DCP application 122 in a client device 110-3 used by consumer 40. Accordingly, consumer 40 may have opted-in to download DCP application 122 so that server 130A may verify at least some of the consumer identity and location by accessing a database 152.

Within DCP application 122, consumer 40 selects a retailer and enters in their associated FSCID (e.g., when the consumer enters a retail store to make a purchase). In some embodiments, DCP application 122 may also collect FSCIDs from a retailer outside a network of selected retailers, along with corresponding scan receipts, when the consumer has purchased an item at the retail store. Server 130A links an identifier for an advertiser (IDFA, for an advertisement of the purchased item) with the FSCID and then backs this into a household identifier (HHID) to build a consumer profile in database 152. When the consumer goes into the retailer store for which a linkage exists (e.g., through an FSCID), DCP application 122 collects the transactional information (e.g., the contents of shopping basket 115). In some embodiments, the transactional information may include the universal product code (UPC) of one or more, or all of the items in shopping basket 115. In some embodiments, the data from the purchase may be collected via an existing application installed in client device 110-3. In some embodiments, DCP application 122 may query consumer 40 regarding the ‘transaction records’ and ‘ask’ consumer 40 to confirm or validate that his/her household made the transaction. In some embodiments, DCP application 122 collects transactional attributes associated with the purchase, such as: Retailer name, Location of purchase, Date/time, Product name, image, quantity, price, etc.

Database 152 may include information about consumer 40, such as a purchasing history and other demographic and psychographic data. In some embodiments, server 130A may scrub any PII for consumer 40 from database 152. The retail store associated with POS 105 may be a client of server 130A. Network terminal 110-2 may be communicatively coupled with server 130A via network 150. Accordingly, in some embodiments, network terminal 110-2 includes a printer configured to print a validated certificate to consumer 40. In some embodiments, network terminal 110-2 includes a secondary display configured to display a validated certificate for consumer 40, or a validation token for a certificate presented by consumer 40. In some embodiments, the purchase data or transaction information may originate via third party companies acting as an agent or a client of server 130A. POS device 110-1, network terminal 110-2, and client device 110-3 will be collectively referred, hereinafter, as “client devices 110.” Client devices 110 may include any computer device such as a desktop computer, a server, a workstation, or a mobile computing device such as a laptop, a smartphone, a notepad, and the like.

A server 130B may be a publishing server providing multimedia files and down-streaming payloads to consumer 40 via client device 110-3. In some embodiments, the down-stream from server 130B may include an advertisement payload for a product (e.g., one or more of the products 50 in shopping basket 115). The advertisement payload may be provided to server 130B by server 130A or any other third party server (hereinafter, collectively referred to as “servers 130”), based on a consumer profile identified by server 130A. The advertisement payload may include a coupon, an offer, or any other value added certificate as a reward for consumer 40 having downloaded DCP application 122. In some embodiments, client device 110-3 may not include DCP application 122 and consumer 40 may not be part of a consumer network in server 130A. However, consumer 40 may still fulfill a consumer profile elaborated by server 130A based on the consumer network of DCP application 122. Accordingly, server 130B may provide an advertisement payload to consumer 40 even when the consumer is not part of the network for DCP application 122 hosted by server 130A.

Servers 130, database 152, and client devices 110 may communicate with each other through network 150, wirelessly or otherwise. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

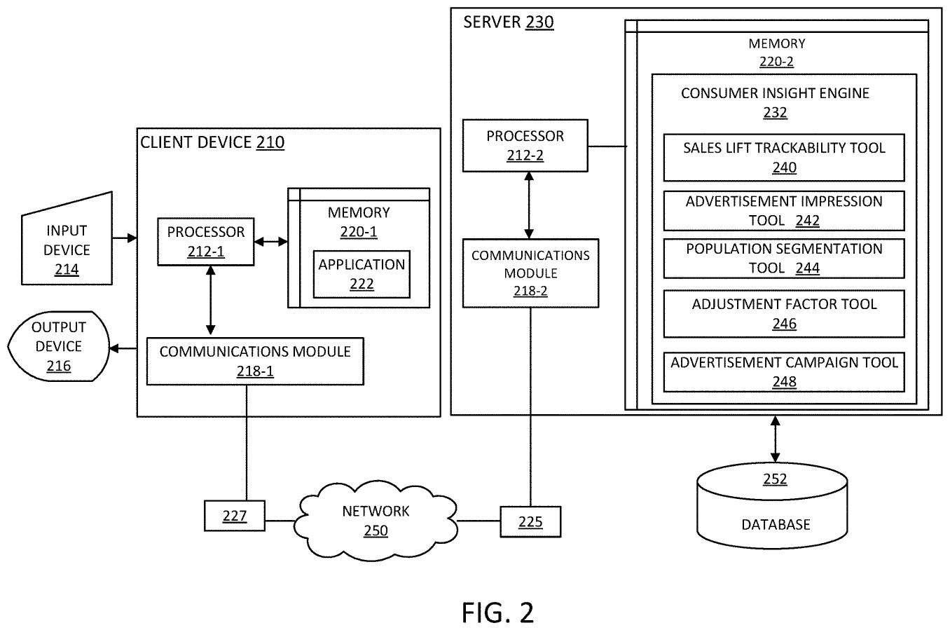

FIG. 2 illustrates details of exemplary devices used in one embodiment of architecture 10, according to some embodiments. A client device 210 is communicatively coupled with a server 230 and a database 252 via a network 250 (e.g., client devices 110, servers 130, network 150, and database 152). Client device 210 and server 230 may include processors 212-1 and 212-2 (hereinafter, collectively referred to as “processors 212”), and memories 220-1 and 220-2 (hereinafter, collectively referred to as “memories 220”), respectively. Memories 220 may be non-transitory, computer-readable media storing instructions which, when executed by processors 212 cause client device 210 and server 230 to perform, at least partially, some of the methods disclosed herein. Client device 210 and server 230 may also include communications modules 218-1 and 218-2 (hereinafter, collectively referred to as “communications modules 218”), respectively. Communications modules 218 may include hardware and software configured according to networking protocols, including Ethernet cards, telephone lines, radio and wireless antennas and associated digital and/or analog circuitry, such as Bluetooth, Wi-Fi, near field contact (NFC) and other radio-frequency (RF) communication schemes, including ultrasound.

Memory 220-1 in client device 210 may include an application 222. Application 222 may include a consumer panel application downloaded from and hosted by a consumer insight engine 232 in memory 220-2 of server 230. Through application 222, server 230 may recover past purchasing behavior, a willingness to try new products, or a sensitivity to advertisements of a consumer handling client device 210. Moreover, consumer insight engine 232 may correlate the data collected for the consumer handling client device 210 with a limited and selected population of consumers (e.g., a consumer segment), via an adjustment factor.

Client device 210 may interact with a user (e.g., a consumer) via an input device 214 and an output device 216. Input device 214 may include a keyboard, a mouse, a pointer, or even a touch-screen display that a consumer may use to interact with client device 210. Likewise, output device 216 may include a display and a speaker with which the consumer may retrieve results from client device 210. In some embodiments, input device 214 and output device 216 may include a graphic user interface configured to provide an interactive display so the consumer may input queries and responses and see data 225 provided by server 230 through application 222. For example, data 225 may include an advertisement payload containing graphic data associated with one or more items for sale at a retailer store. In some embodiments, data 225 may include a value added offer, a promotion, or a discount for the one or more items for sale at the retailer store. Depending on the number of gift card submissions to consumers against their purchases, server 230 may continually incentivize the consumer by providing new gift cards via application 222. In some embodiments, server 230 may include a third party vendor that delivers a gift card in at a data 225 as an incentive for consumer to download application 222 hosted by the third party server, or by another server. In some embodiments, server 230 hosting application 222 may provide digital incentives (load to card offers, and the like) in the form of data 225 to a consumer that opts-in to download and use the application 222.

Likewise, in some embodiments, client device 210 may provide consumer data 227 to consumer insight engine 232 in server 230, via application 222. Consumer data 227 may include information such as a willingness of the consumer to try new products and a sensitivity to advertisements. Consumer data 227 may be scrubbed of any PII associated with a consumer, and stored in database 252, after use.

Consumer insight engine 232 may include multiple tools, such as a sales lift trackability tool 240, an advertisement impression tool 242, a population segmentation tool 244, an adjustment factor tool 246, and an advertisement campaign tool 248.

In some embodiments, sales lift trackability tool 240 scans consumer receipts to correlate purchases down to the UPC, the consumer receipts being part of consumer data 227 provided by application 222. In some embodiments, sales lift trackability tool 240 applies techniques and devices to assess the measurement of a multi-channel campaign by integrating, with adjustment factor tool 246, multiple signals and data sets into an adjustment factor that enables the broadening of the scope of the statistical findings of a campaign designed by advertisement campaign tool 248. In some embodiments, the adjustment factor is representative of a segment of the population in terms of gender, age, location, and other attributes. Accordingly, sales lift trackability tool 240 may modify the adjustment factor based on specific markets such as over-the-counter (OTC), liquors, cosmetics, and the like.

Advertisement impression tool 242 identifies advertisement payloads downloaded by a consumer and correlates this with a corresponding consumer segment identified by population segmentation tool 244. In some embodiments, the consumer segment includes consumers that have expressly agreed to participate in the campaign or have consciously downloaded application 222 in client device 210.

In some embodiments, server 230 may include a digital publishing server providing contextual data from multimedia down-streams via a browser or a mobile network application. In that regard, a digital publishing server may provide information to population segmentation tool 244 as to the types of consumer audience that sees, taps into, or downloads what type of content, what advertisement, and when. In some embodiments, data for sales lift trackability tool 240 may be retrieved from third party partners outside of a server network, providing information as to items being purchased, in what stores, and by what type of consumer.

Some embodiments may include a deterministic kernel as the basis for the sales lift trackability tool 240 that accounts for over-representations of specific demographics or other attributes of a consumer population or segment. In some embodiments, a third party may lease or access sales lift trackability tool 240, to leverage or enhance their own information.

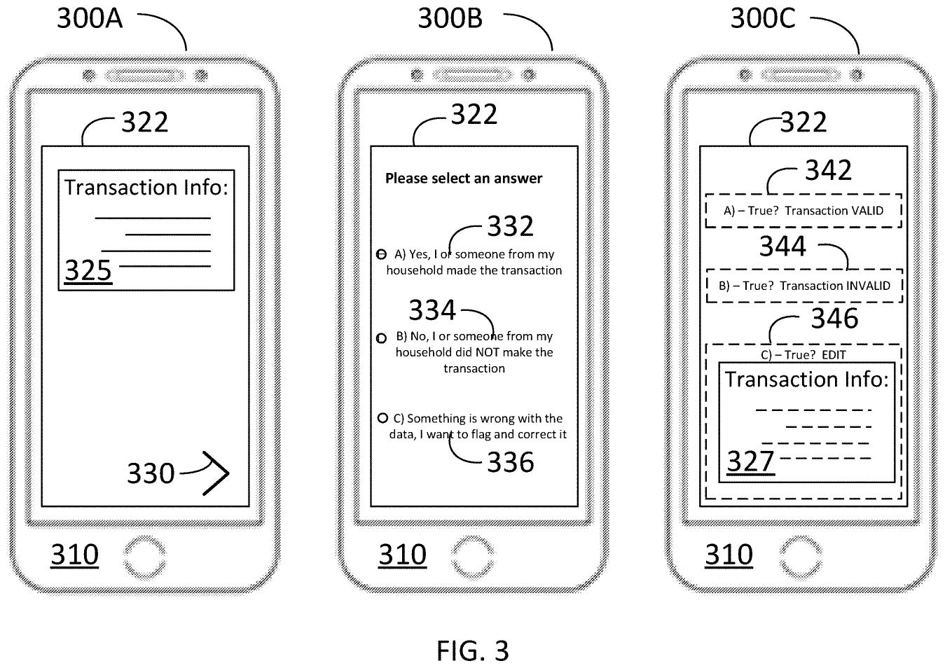

FIG. 3 illustrates screenshots 300A, 300B, and 300C (hereinafter, collectively referred to as “screenshots 300”) of a transaction validation via a consumer panel application 322 in a mobile device 310, according to some embodiments (cf. DCP application 122, application 222, client device 110-3, and client device 210).

In screenshot 300A, application 322 presents a ‘transaction card’ that displays a transaction information 325 for every recent transaction logged (after the consumer has consented and downloaded the application). In some embodiments, the consumer clicks a “NEXT” button 330.

In screenshot 300B, application 322 presents a prompt that may have the following buttons. Button 332: A) “Yes, I or someone from my household made the transaction.” Button 334: B) “No, I or someone from my household did NOT make the transaction.” Button 336: C) “Something is off with the data, I want to flag and correct it.” When the consumer selects button 332, in screenshot 300C, the transaction is logged as VALID in field 342 and transaction info 325 can be used to collect and link digital consumer panel data to a semi-persistent in-store consumer loyalty card identifier. When the consumer selects button 334, in screenshot 300C, the transaction is logged as INVALID in field 344, and transaction info 325 may not be used to collect and link digital consumer panel data to a semi-persistent in-store consumer loyalty card identifier.

When the consumer selects button 336, the consumer may be prompted to correct transaction info 325 in field 346 and to provide updated transaction info 327 to the server through application 322. In some embodiments, this triggers a manual review process on the server side. Accordingly, the server host may be notified (e.g., via a message) that the consumer has provided input to correct the data. The server host may correct the data based on user feedback. After the consumer feedback, the server host may decide when the data is VALID or INVALID. In some embodiments, this verification step may be automated. In some embodiments, the verification step may be manually performed by a server administrator.

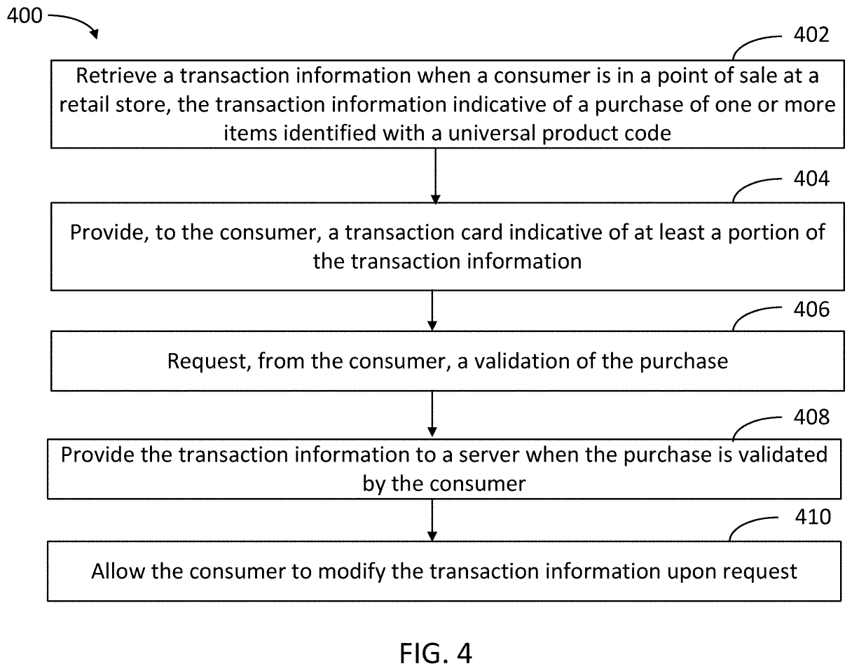

FIG. 4 is a flow chart illustrating steps in a method for soliciting a user generated response to determine if a consumer made a purchase, according to some embodiments. Method 400 may be performed at least partially by a processor executing commands stored in a memory, the processor or memory being part of a server, a client device or a database, communicatively coupled through a network (c.f., processors 212, memories 220, servers 130 and 230, client devices 110 and 210, databases 152 and 252, and networks 150 or 250). Further, in some embodiments, at least some of the steps in method 400 may be performed overlapping in time, almost simultaneously, or in a different order from the order illustrated in method 400. Moreover, a method consistent with some embodiments disclosed herein may include at least one, but not all, of the steps in method 400.

Step 402 includes retrieving a transaction information when a consumer is in a point of sale at a retail store, the transaction information indicative of a purchase of one or more items identified with a UPC.

Step 404 includes providing, to the consumer, a transaction card indicative of at least a portion of the transaction information.

Step 406 includes requesting, from the consumer, a validation of the purchase. In some embodiments, step 406 includes providing the request to a consumer panel application installed in a mobile device for the consumer. In some embodiments, step 406 includes requesting the validation of the transaction to a head of household associated with the consumer at the point of sale at the retail store.

Step 408 includes providing the transaction information to a server when the purchase is validated by the consumer.

Step 410 includes allowing the consumer to modify the transaction information upon request. In some embodiments, step 410 includes providing to a consumer panel application installed in a mobile device for the consumer, an editable version of a transaction receipt. In some embodiments, step 410 includes modifying an adjustment factor correlating the consumer with a population segment based on the transaction information and a history of advertisement downloads from the consumer. In some embodiments, step 410 includes providing a value added incentive to the consumer via a consumer panel application installed in a mobile device for the consumer when the transaction is validated by the consumer. In some embodiments, step 410 includes storing the transaction information in a database when the transaction is validated by the consumer. In some embodiments, step 410 includes correlating the transaction with a download of a payload content associated with the one or more items identified with a unique product code, from a mobile device of the consumer. In some embodiments, step 410 includes correlating the transaction with a download of a payload content by a second consumer in a population segment matching at least one attribute of the consumer, when the transaction is validated by the consumer. In some embodiments, step 410 includes updating an attribute of the consumer in a database based on the transaction information, when the transaction is validated by the consumer.

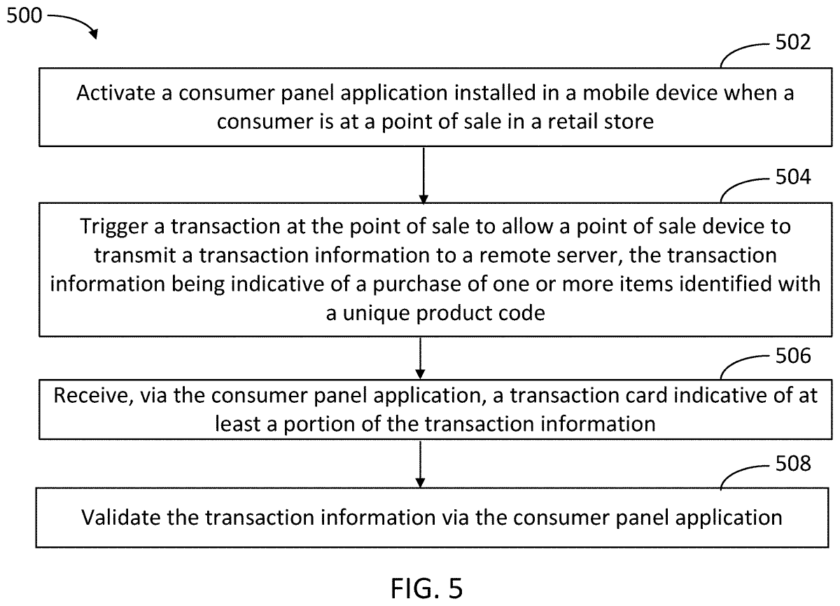

FIG. 5 is a flow chart illustrating steps in a method 500 for validating a transaction at a retail store via a consumer panel application installed in a mobile device, according to some embodiments. Method 500 may be performed at least partially by a processor executing commands stored in a memory, the processor or memory being part of a server, a client device or a database, communicatively coupled through a network (c.f., processors 212, memories 220, servers 130 and 230, client devices 110 and 210, databases 152 and 252, and networks 150 or 250). Further, in some embodiments, at least some of the steps in method 500 may be performed overlapping in time, almost simultaneously, or in a different order from the order illustrated in method 500. Moreover, a method consistent with some embodiments disclosed herein may include at least one, but not all, of the steps in method 500.

Step 502 includes activating the consumer panel application installed in the mobile device when a consumer is at a point of sale in a retail store.

Step 504 includes triggering a transaction at the point of sale to allow a point of sale device to transmit a transaction information to a remote server, the transaction information being indicative of a purchase of one or more items identified with a unique product code.

Step 506 includes receiving, via the consumer panel application, a transaction card indicative of at least a portion of the transaction information.

Step 508 includes validating the transaction information via the consumer panel application. In some embodiments, step 508 includes validating the transaction information from a head of household device associated with a consumer account in the consumer panel application installed in the mobile device of the consumer. In some embodiments, step 508 includes requesting, via the consumer panel application, an editable version of a transaction receipt to modify the transaction information. In some embodiments, step 508 includes installing in the mobile device, a consumer panel application authorizing a remote server to track the transaction with the retail store, and to retrieve a demographic data from the consumer. In some embodiments, step 508 includes receiving a value added incentive via the consumer panel application, when the transaction is validated by the consumer.

### Hardware Overview

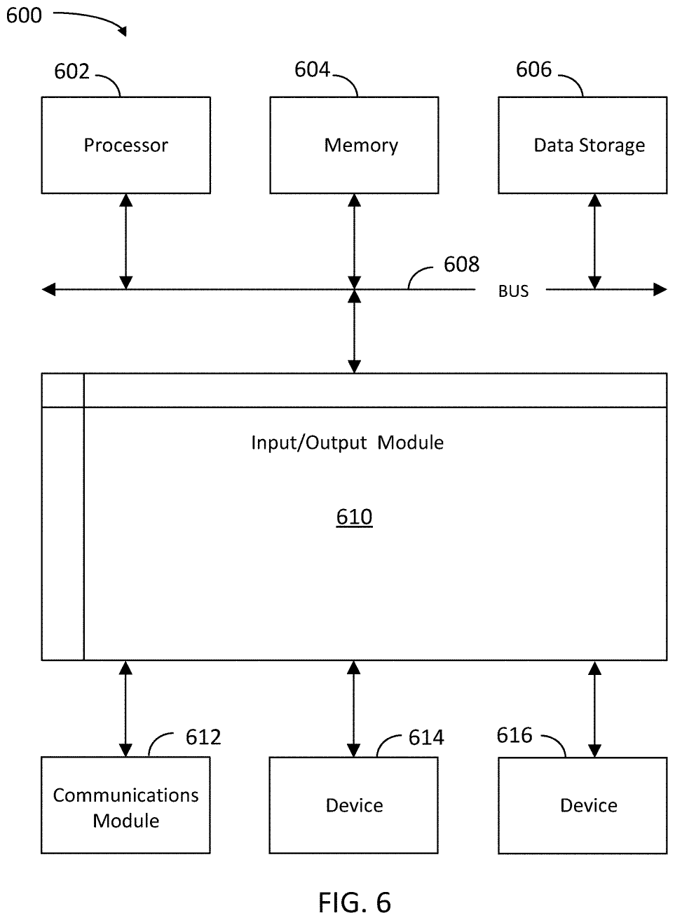

FIG. 6 is a block diagram illustrating an exemplary computer system 600 with which the client device 110 and server 130 of FIGS. 1 and 2, and the methods of FIGS. 4 and 5 can be implemented. In certain aspects, the computer system 600 may be implemented using hardware or a combination of software and hardware, either in a dedicated server, or integrated into another entity, or distributed across multiple entities.

Computer system 600 (e.g., client device 110 and server 130) includes a bus 608 or other communication mechanism for communicating information, and a processor 602 (e.g., processors 212) coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, e.g., one or more modules of computer program instructions encoded on a computer-readable medium for execution by, or to control the operation of, the computer system 600, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off- side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and inter-coupled by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled with bus 608 for storing information and instructions. Computer system 600 may be coupled via input/output module 610 to various devices. Input/output module 610 can be any input/output module. Exemplary input/output modules 610 include data ports such as USB ports. The input/output module 610 is configured to connect to a communications module 612. Exemplary communications modules 612 (e.g., communications modules 218) include networking interface cards, such as Ethernet cards and modems. In certain aspects, input/output module 610 is configured to connect to a plurality of devices, such as an input device 614 (e.g., input device 214) and/or an output device 616 (e.g., output device 216). Exemplary input devices 614 include a keyboard and a pointing device, e.g., a mouse or a trackball, by which a consumer can provide input to the computer system 600. Other kinds of input devices 614 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 616 include display devices, such as an LCD (liquid crystal display) monitor, for displaying information to the consumer.

According to one aspect of the present disclosure, the client device 110 and server 130 can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be inter-coupled by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires forming bus 608. Common forms of machine-readable media include, for example, floppy disk, a flexible disk, hard disk, magnetic tape, any other magnetic medium, a CD- ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

### RECITATION OF EMBODIMENTS

Embodiments consistent with the present disclosure include:

Embodiment I is a computer-implemented method, including retrieving a transaction information when a consumer is in a point of sale at a retail store, the transaction information being indicative of a purchase of a one or more items identified with a unique product code when a transaction is triggered by a consumer panel application installed in a mobile device of the consumer, providing, to the consumer, a transaction card indicative of at least a portion of the transaction information, requesting, from the consumer, a validation of the transaction, providing the transaction information to a server when the transaction is validated by the consumer, and allowing the consumer to modify the transaction information upon request.

Embodiment II is a system including a memory configured to store multiple instructions and one or more processors configured to execute the instructions to cause the system to perform actions. The actions include to retrieve a transaction information when a consumer is in a point of sale at a retail store, the transaction information being indicative of a purchase of one or more items identified with a unique product code when a transaction is triggered by a consumer panel application installed in a mobile device of the consumer, to provide, to the consumer, a transaction card indicative of at least a portion of the transaction information, to request, from the consumer, a validation of the transaction, to provide the transaction information to a server when the transaction is validated by the consumer, and to allow the consumer to modify the transaction information upon request.

Embodiment III is a computer-implemented method, including activating a consumer panel application installed in a mobile device when a consumer is at a point of sale in a retail store, triggering a transaction at the point of sale to allow a point of sale device to transmit a transaction information to a remote server, the transaction information being indicative of a purchase of one or more items identified with a unique product code, receiving, via the consumer panel application, a transaction card indicative of at least a portion of the transaction information, and validating the transaction information via the consumer panel application.

In addition, embodiments consistent with the present disclosure may include any of embodiments I, II, and III in combination with any number of the following elements, in any order or permutation.

Element 1, wherein requesting from the consumer a validation of the transaction includes providing the request to a consumer panel application installed in a mobile device for the consumer. Element 2, wherein requesting from the consumer a validation of the transaction includes requesting the validation of the transaction to a head of household associated with the consumer at the point of sale at the retail store. Element 3, wherein allowing the consumer to modify the transaction information upon request includes providing, to a consumer panel application installed in a mobile device for the consumer, an editable version of a transaction receipt. Element 4, further including modifying an adjustment factor correlating the consumer with a population segment based on the transaction information and a history of advertisement downloads from the consumer. Element 5, further including providing a value added incentive to the consumer via a consumer panel application installed in a mobile device for the consumer when the transaction is validated by the consumer. Element 6, further including storing the transaction information in a database when the transaction is validated by the consumer. Element 7, further including correlating the transaction with a download of a payload content associated with the one or more items identified with a unique product code, from a mobile device of the consumer. Element 8, further including correlating the transaction with a download of a payload content by a second consumer in a population segment matching at least one attribute of the consumer, when the transaction is validated by the consumer. Element 9, further including updating an attribute of the consumer in a database based on the transaction information, when the transaction is validated by the consumer.

Element 10, wherein to request a validation of the transaction the one or more processors execute instructions to provide the request to a consumer panel application installed in a mobile device for the consumer. Element 11, wherein to request a validation of the transaction the one or more processors execute instructions to request the validation of the transaction to a head of household associated with the consumer at the point of sale at the retail store. Element 12, wherein to allow the consumer to modify the transaction information upon request the one or more processors execute instructions to provide, to a consumer panel application installed in a mobile device for the consumer, an editable version of a transaction receipt.

Element 13, further including allowing the consumer to modify the transaction information upon request. Element 14, wherein validating the transaction information includes validating the transaction information from a head of household device associated with a consumer account in the consumer panel application installed in the mobile device of the consumer. Element 15, wherein validating the transaction information includes requesting, via the consumer panel application, an editable version of a transaction receipt to modify the transaction information. Element 16, further including installing in the mobile device, a consumer panel application authorizing a remote server to track the transaction with the retail store, and to retrieve a demographic data from the consumer. Element 17, further including receiving a value added incentive via the consumer panel application, when the transaction is validated by the consumer.

1. A computer-implemented method, comprising:
retrieving a transaction information when a consumer is in a point of sale at a retail store, the transaction information being indicative of a purchase of a one or more items identified with a unique product code when a transaction is triggered by a consumer panel application installed in a mobile device of the consumer;
providing, to the consumer, a transaction card indicative of at least a portion of the transaction information;
requesting, from the consumer, a validation of the transaction;
providing the transaction information to a server when the transaction is validated by the consumer; and
allowing the consumer to modify the transaction information upon request.

2. The computer-implemented method of claim 1, wherein requesting from the consumer a validation of the transaction comprises providing the request to a consumer panel application installed in a mobile device for the consumer.

3. The computer-implemented method of claim 1, wherein requesting from the consumer a validation of the transaction comprises requesting the validation of the transaction to a head of household associated with the consumer at the point of sale at the retail store.

4. The computer-implemented method of claim 1, wherein allowing the consumer to modify the transaction information upon request comprises providing, to a consumer panel application installed in a mobile device for the consumer, an editable version of a transaction receipt.

5. The computer-implemented method of claim 1, further comprising modifying an adjustment factor correlating the consumer with a population segment based on the transaction information and a history of advertisement downloads from the consumer.

6. The computer-implemented method of claim 1, further comprising providing a value added incentive to the consumer via a consumer panel application installed in a mobile device for the consumer when the transaction is validated by the consumer.

7. The computer-implemented method of claim 1, further comprising storing the transaction information in a database when the transaction is validated by the consumer.

8. The computer-implemented method of claim 1, further comprising correlating the transaction with a download of a payload content associated with the one or more items identified with a unique product code, from a mobile device of the consumer.

9. The computer-implemented method of claim 1, further comprising correlating the transaction with a download of a payload content by a second consumer in a population segment matching at least one attribute of the consumer, when the transaction is validated by the consumer.

10. The computer-implemented method of claim 1, further comprising updating an attribute of the consumer in a database based on the transaction information, when the transaction is validated by the consumer.

11. A system, comprising;
a memory configured to store multiple instructions; and
one or more processors configured to execute the instructions to cause the system to:
retrieve a transaction information when a consumer is in a point of sale at a retail store, the transaction information being indicative of a purchase of one or more items identified with a unique product code when a transaction is triggered by a consumer panel application installed in a mobile device of the consumer,
provide, to the consumer, a transaction card indicative of at least a portion of the transaction information,
request, from the consumer, a validation of the transaction,
provide the transaction information to a server when the transaction is validated by the consumer, and
allow the consumer to modify the transaction information upon request.

12. The system of claim 11, wherein to request a validation of the transaction the one or more processors execute instructions to provide the request to a consumer panel application installed in a mobile device for the consumer.

13. The system of claim 11, wherein to request a validation of the transaction the one or more processors execute instructions to request the validation of the transaction to a head of household associated with the consumer at the point of sale at the retail store.

14. The system of claim 11, wherein to allow the consumer to modify the transaction information upon request the one or more processors execute instructions to provide, to a consumer panel application installed in a mobile device for the consumer, an editable version of a transaction receipt.

15. A computer-implemented method, comprising:
activating a consumer panel application installed in a mobile device when a consumer is at a point of sale in a retail store;
triggering a transaction at the point of sale to allow a point of sale device to transmit a transaction information to a remote server, the transaction information being indicative of a purchase of one or more items identified with a unique product code;
receiving, via the consumer panel application, a transaction card indicative of at least a portion of the transaction information; and
validating the transaction information via the consumer panel application.

16. The computer-implemented method of claim 15, further comprising allowing the consumer to modify the transaction information upon request.

17. The computer-implemented method of claim 15, wherein validating the transaction information comprises validating the transaction information from a head of household device associated with a consumer account in the consumer panel application installed in the mobile device of the consumer.

18. The computer-implemented method of claim 15, wherein validating the transaction information comprises requesting, via the consumer panel application, an editable version of a transaction receipt to modify the transaction information.

19. The computer-implemented method of claim 15, further comprising installing in the mobile device, a consumer panel application authorizing a remote server to track the transaction with the retail store, and to retrieve a demographic data from the consumer.

20. The computer-implemented method of claim 1, further comprising receiving a value added incentive via the consumer panel application, when the transaction is validated by the consumer.
